(19) United States
(12) Patent Application Publication
(10) Pub. No.: US 2025/0329562 A1
(43) Pub. Date: Oct. 23, 2025

(54) INFORMATION PROCESSING APPARATUS, INFORMATION PROCESSING METHOD, AND STORAGE MEDIUM

(71) Applicant: Tokyo Electron Limited, Tokyo (JP)

(72) Inventors: Daigo FURUYA, Iwate (JP); Masakazu YAMAMOTO, Iwate (JP); Hiroyuki KARASAWA, Yamanashi (JP); Tadashi ENOMOTO, Iwate (JP)

(21) Appl. No.: 19/172,994

(22) Filed: Apr. 8, 2025

(30) Foreign Application Priority Data
Apr. 19, 2024 (JP) 2024-068110

(51) Int. Cl. H01L 21/67; G06F 30/337; G06F 119/08

(52) U.S. Cl. CPC H01L 21/67248; G06F 30/337; G06F 2119/08

(57) ABSTRACT

An information processing apparatus includes: a model acquisition unit that acquires a trained model that predicts temperature inside a processing container included in a first substrate processing apparatus; a data acquisition unit that acquires sensor data indicating a sensor value obtained by measuring temperature inside a processing container included in a second substrate processing apparatus; an optimization unit that optimizes a parameter indicating a difference in temperature responsiveness between the first substrate processing apparatus and the second substrate processing apparatus based on the trained model and the sensor data; and a prediction unit that predicts the temperature inside the processing container included in the second substrate processing apparatus based on the trained model and the parameter.

### CROSS-REFERENCE TO RELATED APPLICATIONS

This application is based on and claims priority from Japanese Patent Application No. 2024-068110, filed on Apr. 19, 2024, with the Japan Patent Office, the disclosure of which is incorporated herein in its entirety by reference.

### TECHNICAL FIELD

The present disclosure relates to an information processing apparatus, an information processing method, and a storage medium.

### BACKGROUND

A technology for predicting the temperature inside a processing container that processes an object to be processed is known. For example, Japanese Patent Application Laid-Open Publication No. 2005-026397 discloses a calibration method for a heat treatment apparatus that includes a processing container accommodating an object to be processed (“workpiece”), a plurality of heaters, and a plurality of temperature sensors. The heat treatment apparatus stores a thermal model for estimating the temperature of the workpiece inside the processing container based on the output of the temperature sensors, predicts the temperature of the workpiece inside the processing container using the thermal model based on the output of the temperature sensors, and controls heaters based on the predicted temperature, thereby performing heat treatment on the workpiece.

### SUMMARY

According to an aspect of the present disclosure, an information processing apparatus includes: a model acquisition unit that acquires a trained model that predicts temperature inside a processing container included in a first substrate processing apparatus; a data acquisition unit that acquires sensor data indicating a sensor value obtained by measuring a temperature inside a processing container included in a second substrate processing apparatus; an optimization unit that configured to optimize a parameter indicating a difference in temperature responsiveness between the first substrate processing apparatus and the second substrate processing apparatus based on the trained model and the sensor data; and a prediction unit that predicts the temperature inside the processing container included in the second substrate processing apparatus based on the trained model and the parameter.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an example of the overall configuration of a substrate processing system.

FIG. 2 is a schematic cross-sectional view illustrating an example of a substrate processing apparatus.

FIG. 3 is a block diagram illustrating an example of a computer hardware configuration.

FIG. 4 is a block diagram illustrating an example of the functional configuration of a prediction apparatus.

FIG. 5 is a flowchart illustrating an example of an optimization process.

FIG. 6 is a flowchart illustrating an example of a prediction process.

FIG. 7 is a view illustrating an example of an operation flow of a prediction apparatus.

FIG. 8 is a diagram illustrating an example of a search process in Bayesian optimization.

FIG. 9 is a diagram illustrating an example of the comparison results of prediction errors before and after optimization.

FIG. 10 is a diagram illustrating an example of prediction accuracy before optimization.

FIG. 11 is a diagram illustrating an example of prediction accuracy after optimization.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made without departing from the spirit or scope of the subject matter presented here.

Hereinafter, embodiments of the present disclosure will be described with reference to the accompanying drawings. In each of the drawings, the same components may be denoted by the same reference numerals, and redundant descriptions thereof may be omitted.

### Embodiments

An embodiment of the present disclosure is a substrate processing system that processes a substrate, which is an example of a workpiece. In the present embodiment, the substrate processing system includes a substrate processing apparatus that thermally processes a semiconductor wafer, which is an example of a substrate, inside a processing container. The substrate processing system also includes a prediction apparatus that predicts the temperature inside the processing container, where the semiconductor wafer is thermally processed (hereinafter, also referred to as a “furnace temperature”).

In the related art, a prediction model for predicting the furnace temperature is constructed based on sensor data indicating sensor values measured by temperature sensors provided in a reference substrate processing apparatus (hereinafter, also referred to as a “reference apparatus”). Since there are differences among individual substrate processing apparatuses, when predicting the furnace temperature for a substrate processing apparatus other than the reference apparatus (hereinafter, also referred to as a “target apparatus”), the prediction accuracy may decrease. Hereinafter, the prediction model constructed using the sensor data of the reference apparatus is also referred to as a “reference model.” The reference apparatus is an example of a first substrate processing apparatus. The target apparatus is an example of a second substrate processing apparatus.

Since various changes occur in a substrate processing apparatus over time, even a prediction model that had sufficient prediction accuracy at a past point in time may experience a decline in prediction accuracy over time. In addition, in recent years, substrate processing apparatuses have been increasing in longevity, and errors due to aging tend to become larger.

The conventional technology constructs a prediction model based on sensor data obtained during temperature stabilization and does not assume the prediction of furnace temperature outside the temperature stabilization period. Furthermore, the impact of changes in the substrate processing apparatus over time on prediction accuracy is not considered. Since the conventional technology requires the execution of a special process to set up the substrate processing apparatus, the cost of constructing the prediction model is high, and it is also difficult to reconstruct the prediction model after the substrate processing apparatus has started operation.

In recent years, process recipes executed in substrate processing apparatuses have become more complex, making it important to save energy throughout the entire process recipe. Accurate furnace temperature prediction throughout the entire process recipe may enable optimal temperature settings, improving energy utilization efficiency. Even if the prediction accuracy improves only immediately after the construction of the prediction model and during temperature stabilization, it may be difficult to improve the prediction accuracy for the entire process recipe.

The present embodiment aims to improve the prediction accuracy of the furnace temperature. To this reason, in the present embodiment, the predicted value of the furnace temperature output by the reference model is corrected using a parameter that represents the difference in temperature responsiveness between the reference apparatus and the target apparatus.

In an aspect, according to the present embodiment, since the furnace temperature is predicted in consideration of the difference in temperature responsiveness between the reference apparatus and the target apparatus, the furnace temperature of the target apparatus may be predicted with high accuracy. In another aspect, according to the present embodiment, when sensor data measured during the execution of the process recipe is available, the parameter may be optimized, allowing the target apparatus to be easily adapted to changes in the target apparatus over time.

### <System Configuration>

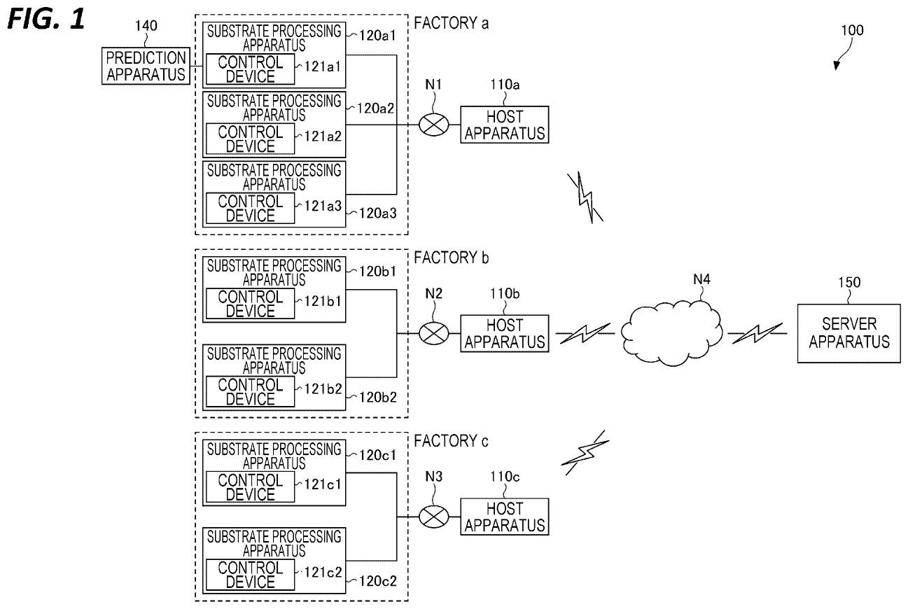

The overall configuration of the substrate processing system in the present embodiment will be described with reference to FIG. 1. FIG. 1 is a block diagram illustrating an example of the overall configuration of the substrate processing system.

As illustrated in FIG. 1, the substrate processing system 100 includes substrate processing apparatuses 120al to 120a3 and control devices 121al to 121a3 in factory a. The substrate processing apparatuses 120al to 120a3 and the control devices 121al to 121a3 are connected via wired or wireless communication.

The substrate processing system 100 also includes substrate processing apparatuses 120b1 and 120b2 and control devices 121b1 and 121b2 in factory b. The substrate processing apparatuses 120b1 and 120b2 and the control devices 121b1 and 121b2 are connected via wired or wireless communication.

The substrate processing system 100 also includes substrate processing apparatuses 120c1 and 120c2 and control devices 121c1 and 121c2 in factory c. The substrate processing apparatuses 120c1 and 120c2 and the control devices 121c1 and 121c2 are connected via wired or wireless communication.

The substrate processing apparatuses 120al to 120a3, the substrate processing apparatuses 120b1 and 120b2, and the substrate processing apparatuses 120c1 and 120c2 are connected to respective host apparatuses 110a, 110b, and 110c via networks N1 to N3. Each substrate processing apparatus executes substrate processing under the control of respective control devices, which operate based on instructions from the host apparatuses 110a, 110b, and 110c. The host apparatuses 110a, 110b, and 110c are connected to a server apparatus 150 via a network N4, such as the Internet.

In the following description, the substrate processing apparatuses 120al to 120a3, 120bl, 120b2, 120cl, and 120c2 may be collectively referred to as a substrate processing apparatus 120. Similarly, the control devices 121al to 121a3, 121bl, 121b2, 121c1, and 121c2 may be collectively referred to as a control device 121. The host apparatuses 110a, 110b, and 110c may be collectively referred to as a host apparatus 110.

It is assumed that each of the substrate processing apparatuses 120al to 120a3, 120bl, 120b2, 120c1, and 120c2 manages and stores a wide range of data in an own apparatus thereof.

The prediction apparatus 140 is connected to the substrate processing apparatuses 120, including the substrate processing apparatus 120al, and continuously acquires the stored data accumulated in each substrate processing apparatuses 120. The example in FIG. 1 illustrates the state where the prediction apparatus 140 is connected to the substrate processing apparatuses 120al, but is not limited thereto. Hereinafter, in the present embodiment, details will be described for the case where the prediction apparatus 140 is connected to the substrate processing apparatus 120al.

The substrate processing system 100 illustrated in FIG. 1 is merely an example, and of course, various system configurations are possible depending on the application and purpose. The classification of apparatuses, such as the host apparatuses 110, the substrate processing apparatuses 120, the control devices 121, the prediction apparatus 140, and the server apparatuses 150, as illustrated in FIG. 1, is also an example. For example, the number of factories, the number of host apparatuses 110, the number of substrate processing apparatuses 120, the number of control devices 121, and the number of prediction apparatuses 140 are merely examples and are not limited thereto.

For example, the substrate processing system 100 may have various configurations, such as one where at least two of the host apparatus 110, the substrate processing apparatus 120, the control device 121, prediction apparatus 140, and the server apparatus 150 are integrated, or one where they are further divided. For example, the control device 121 may be configured to collectively control a plurality of substrate processing apparatuses 120, may be provided in a one-to-one configuration with each substrate processing apparatus 120, or may be integrated with the substrate processing apparatus 120.

The prediction apparatus 140 may be implemented by the host apparatus 110 or by the server apparatus 150. In this case, the prediction apparatus 140 becomes unnecessary. In addition, the prediction apparatus 140 may be implemented by the control device 121. The prediction apparatus 140 may also be implemented by a control device that collectively controls a plurality of control devices 121.

### <Substrate Processing Apparatus>

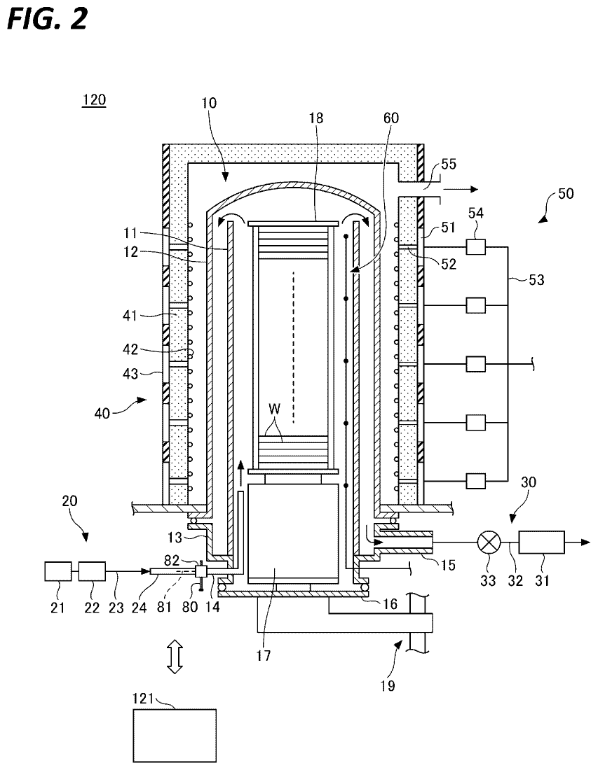

An example of the substrate processing apparatus in the present embodiment will be described with reference to FIG. 2. FIG. 2 is a schematic cross-sectional view illustrating an example of a substrate processing apparatus, specifically a vertical heat treatment apparatus.

The vertical heat treatment apparatus 120 in the present embodiment is a substrate processing apparatus that accommodates a plurality of semiconductor wafers W, as an example of workpieces, at once to perform heat treatments such as oxidation, diffusion, and low-pressure chemical vapor deposition (CVD). As illustrated in FIG. 2, the vertical heat treatment apparatus 120 includes, for example, a processing container 10, a gas supply unit 20, an exhaust unit 30, a heating unit 40, a cooling unit 50, and a control device 121.

The processing container 10 has a substantially cylindrical shape. The processing container 10 includes, for example, an inner tube 11, an outer tube 12, a manifold 13, an injector 14, a gas outlet 15, and a lid 16. The inner tube 11 has a substantially cylindrical shape. The outer tube 12 has a substantially cylindrical shape with a ceiling and forms a double-tube structure together with the inner tube 11. The inner tube 11 and the outer tube 12 are formed of a heat-resistant material such as quartz.

The manifold 13 has a substantially cylindrical shape. The manifold 13 supports the lower ends of the inner tube 11 and the outer tube 12. The manifold 13 is formed of, for example, stainless steel. The injector 14 penetrates through the manifold 13 and extends horizontally into the inner tube 11, then bends at an L-shape inside the inner tube 11 and extends upward. The injector 14 has a base end connected to a gas introduction pipe 24 and an open tip end. The injector 14 injects a processing gas (hereinafter, also simply referred to as a “gas”) introduced through the gas introduction pipe 24 from the open tip end into the inner tube 11. The injector 14 may include a plurality of injectors.

The gas outlet 15 is formed in the manifold 13. The processing gas is exhausted via the gas outlet 15 by the exhaust unit 30. The lid 16 hermetically seals the lower opening of the manifold 13. The lid 16 is formed of, for example, stainless steel. A wafer boat (substrate holder) 18 is placed on the lid 16 via a heat-retaining tube 17. The heat-retaining tube 17 and the wafer boat 18 are formed of, for example, a heat-resistant material such as quartz.

The wafer boat 18 holds a plurality of semiconductor wafers W substantially horizontally with predetermined vertical spacing. The wafer boat 18 is loaded into the processing container 10 when an elevator mechanism raises the lid 16 and is accommodated inside the processing container 10. The wafer boat 18 is unloaded from the processing container 10 when the elevator mechanism 19 lowers the lid 16.

The gas supply unit 20 includes a gas source 21, an integrated gas system (IGS) 22, an external pipe 23, and a gas introduction pipe 24. The gas source 21 serves as a source for the processing gas and includes, for example, a deposition gas source, a cleaning gas source, and a purge gas source. The IGS 22 is an integrated circuit of gas piping, in which a group of pipes respectively connected to the deposition gas source, the cleaning gas source, and the purge gas source of the gas source 21 are integrated. A flow control unit is installed in the IGS 22 to regulate the flow rate of gas through each pipe. The flow control unit includes, for example, a mass flow controller and an opening/closing valve.

The IGS 22 is connected to the external pipe 23. The external pipe 23 is connected to the gas introduction pipe 24. A heater (not illustrated) is wound around the outer circumference of the external pipe 23 to heat it. The gas introduction pipe 24 is connected to the processing container 10 and introduces gas into the processing container 10. That is, the flow control unit in the IGS 22 controls the flow rate of the processing gas from the gas source 21, and the gas is heated while passing through the external pipe 23 and is then supplied from the introduction pipe 24 into the processing container 10 through the injector 14. The injector 14 functions as a gas inlet of the processing container 10.

Near the gas inlet of the processing container 10, a gas pipe joint 82 connected to the gas introduction pipe 24 is provided. A temperature sensor 80 is configured to penetrate through the joint 82. The temperature sensor 80 is configured to measure the temperature of the gas inside the gas introduction pipe 24. The temperature sensor 80 transmits the measured temperature to the control device 121. In addition, a second heater 81 is disposed inside the gas introduction pipe 24. The second heater 81 is configured to heat the gas inside the gas introduction pipe 24.

The exhaust unit 30 includes an exhaust apparatus 31, an exhaust pipe 32, and a pressure controller 33. The exhaust apparatus 31 is a vacuum pump, such as a dry pump or a turbo molecular pump. The pressure controller 33 is installed in the exhaust pipe 32 and controls the pressure inside the processing container 10 by adjusting the conductance of the exhaust pipe 32. The pressure controller 33 is, for example, an automatic pressure control valve.

The heating unit 40 includes an insulating material 41, a first heater 42, and an outer shell 43. The insulating material 41 has a substantially cylindrical shape and is provided around the outer tube 12. The heat insulating material 41 is formed mainly of silica and alumina. The first heater 42 has a linear shape and is provided in a helical or serpentine pattern along the inner circumference of the insulating material 41. The first heater 42 is configured to enable temperature control in a plurality of zones along the height direction of the processing container 10. The outer shell 43 is provided to cover the outer circumference of the insulating material 41. The outer shell 43 maintains the shape of the insulating material 41 and reinforces the insulating material 41. The outer shell 43 is formed of a metal such as stainless steel. In addition, to suppress thermal effects outside the heating unit 40, a water-cooling jacket may be provided around the outer circumference of the outer shell 43. The heating unit 40 heats the inside of the processing container 10 by generating heat from the first heater 42.

The cooling unit 50 supplies a cooling fluid toward the processing container 10 to cool the semiconductor wafers W inside the processing container 10. The cooling fluid may be, for example, air. The cooling unit 50 supplies cooling fluid to the processing container 10, for example, when rapidly cooling the semiconductor wafers W after heat treatment. The cooling unit 50 has a fluid flow path 51, an ejection hole 52, a distribution flow path 53, a flow rate adjustment unit 54, and a heat exhaust port 55.

A plurality of fluid flow paths 51 are formed in the height direction between the insulating material 41 and the outer shell 43. The fluid flow paths 51 are, for example, flow paths formed along the circumferential direction outside the insulating material 41. The ejection hole 52 is formed through the insulating material 41 from each of the fluid flow paths 51 to eject the cooling fluid into the space between the outer tube 12 and the insulating material 41. The distribution flow path 53 is provided outside the outer shell 43 and distributes and supplies cooling fluid to each fluid flow path 51. The flow rate adjustment unit 54 is installed in the distribution flow path 53 and adjusts the flow rate of the cooling fluid supplied to the fluid flow path 51.

The heat exhaust port 55 is provided above a plurality of ejection holes 52 and discharges the cooling fluid supplied into the space between the outer tube 12 and the insulating material 41 to the outside of the processing container 10. The cooling fluid discharged outside the processing container 10 may be cooled, for example, by a heat exchanger and then supplied back to the distribution flow path 53. However, the cooling fluid discharged outside the processing container 10 may also be released without being reused.

The temperature sensor 60 detects the temperature inside the processing container 10. The temperature sensor 60 is provided, for example, inside the inner tube 11. However, the temperature sensor 60 only needs to be positioned where it can detect the temperature inside the processing container 10 and may be placed, for example, in the space between the inner tube 11 and the outer tube 12. The temperature sensor 60 includes, for example, a plurality of temperature measurement units positioned at different heights corresponding to a plurality of zones. The plurality of temperature measurement units may be, for example, thermocouples or resistance temperature measurement elements. The temperature sensor 60 transmits the detected temperatures from the plurality of temperature measurement units to the control device 121.

The control device 121 controls the operation of the vertical heat treatment apparatus 120 to control the semiconductor process executed by the vertical heat treatment apparatus 120. The control device 121 may be, for example, a computer.

### <Computer>

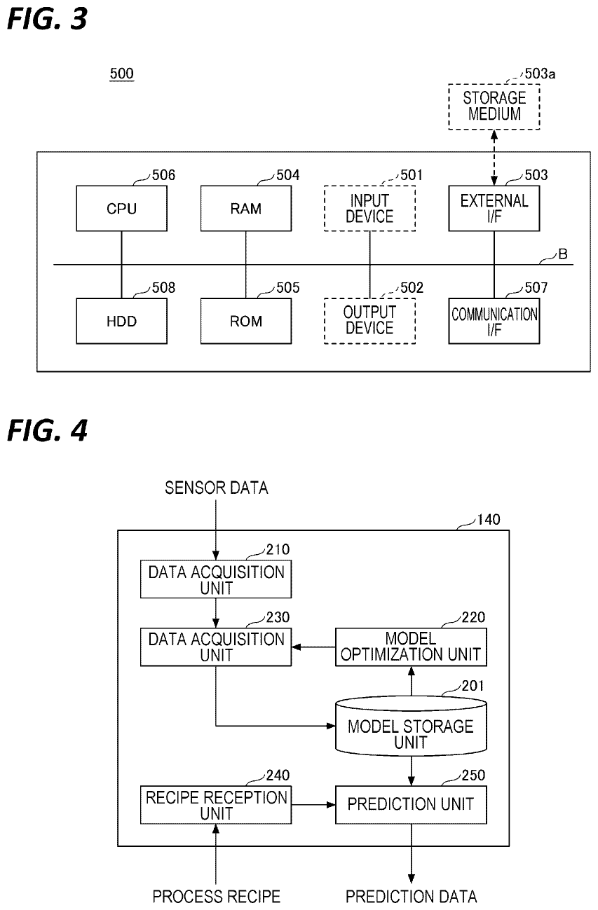

The host apparatus 110, the control device 121, the prediction apparatus 140, and the server apparatus 150 included in the substrate processing system 100 illustrated in FIG. 1 are implemented by computers with hardware configurations such as that illustrated in FIG. 3. FIG. 3 is a block diagram illustrating an example of a computer hardware configuration.

As illustrated in FIG. 3, the computer 500 includes, for example, an input device 501, an output device 502, an external interface (I/F) 503, random access memory (RAM) 504, read-only memory (ROM) 505, a central processing unit (CPU) 506, a communication interface (I/F) 507, and a hard disk drive (HDD) 508, all of which are interconnected via a bus B. The input device 501 and the output device 502 may be connected and used only when necessary.

The input device 501 includes, for example, a keyboard, a mouse, or a touch panel, and is used by an operator to input various operation signals. The output device 502 is, for example, a display, and is used to present processing results from the computer 500. The communication I/F 507 is an interface that connects the computer 500 to a network. The HDD 508 is an example of a non-volatile storage device that stores programs and data.

The external I/F 503 serves as an interface with external devices. The computer 500 may read from and/or write to a recording medium 503a, such as a secure digital (SD) memory card, via the external I/F 503. The ROM 505 is an example of a non-volatile semiconductor memory (storage device) that stores programs and data. The RAM 504 is an example of a volatile semiconductor memory (storage device) that temporarily stores programs and data.

The CPU 506 is a processing unit that reads programs and data from storage devices such as the ROM 505 and the HDD 508 onto the RAM 504 and executes processes to implement overall control and functions of the computer 500.

### <Functional Configuration>

The functional configuration of the prediction apparatus in the present embodiment will be described with reference to FIG. 4. FIG. 4 is a block diagram illustrating an example of the functional configuration of the prediction apparatus.

As illustrated in FIG. 4, the prediction apparatus 140 includes a model storage unit 201, a data acquisition unit 210, a model acquisition unit 220, an optimization unit 230, a recipe reception unit 240, and a prediction unit 250. The prediction apparatus 140 functions as the model storage unit 201, the data acquisition unit 210, the model acquisition unit 220, the optimization unit 230, recipe reception unit 240, and the prediction unit 250 by executing a pre-installed prediction program.

The model storage unit 201 is implemented, for example, by the RAM 504 or the HDD 508 illustrated in FIG. 3. The data acquisition unit 210, the model acquisition unit 220, the optimization unit 230, the recipe reception unit 240, and the prediction unit 250 are implemented, for example, when the CPU 506 illustrated in FIG. 3 executes a program loaded onto the RAM 504.

The model storage unit 201 stores a pre-trained prediction model in advance. The pre-trained prediction model includes a reference model and correction parameters. However, in the initial state, the correction parameters may not be included in the prediction model. Alternatively, in the initial state, the prediction model may include correction parameters set with predetermined initial values.

The reference model is a machine learning model that predicts the temperature (furnace temperature) inside the processing container 10 of the substrate processing apparatus 120. The reference model is trained to predict the furnace temperature of the reference apparatus based on sensor data indicating sensor values measured by the temperature sensor 60 installed in the reference apparatus. The reference model takes control information related to the control of the furnace temperature as input and outputs a predicted value of the furnace temperature. The control information related to furnace temperature control may include the power of the heating unit 40, which heats the inside of the processing container 10, and the output of the cooling unit 50, which cools the inside of the processing container 10.

The prediction model corrects the predicted value output by the reference model using correction parameters. The correction parameters are parameters indicating the difference in temperature responsiveness between the reference apparatus and the target apparatus. Temperature responsiveness may be, for example, a temperature change that occurs when the temperature of the processing container is controlled based on predetermined control information. The difference in temperature responsiveness may be the ratio of the furnace temperature in each of the reference apparatus and the target apparatus when the heating unit 40 and the cooling unit 50 are operated based on the same control information.

Specifically, the prediction model is defined by Equation (1):

$$y ( k ) = f * u ( k ) + G ( u ) , \qquad ( 1 )$$

$$G ( u ) = g \times u ( k )$$

Here, k is a time index, y(k) is a predicted value of furnace temperature at time k, f is a reference model, u(k) is control information related to temperature control at time k, G(u) is a correction term, and g is a correction matrix. The correction matrix g is an example of a correction parameter.

The predicted value y is a vector that includes a predicted furnace temperature for each zone. The control information u is a vector that includes the power of the heating unit 40 and the output of the cooling unit 50 corresponding to each zone. The correction matrix g is a matrix that includes correction coefficients for each zone.

The data acquisition unit 210 acquires sensor data measured in the target apparatus. The sensor data is time-series data that includes actual measured values of the furnace temperature obtained by the temperature sensor installed in the target apparatus. The data acquisition unit 210 may also acquire the process recipe executed when the sensor data was generated. The process recipe may include a plurality of processes with different set temperatures for the processing container 10.

The model acquisition unit 220 acquires a pre-trained prediction model. The model acquisition unit 220 may read a prediction model stored in the model storage unit 201. The pre-trained prediction model includes the reference model and correction parameters.

The optimization unit 230 optimizes the correction parameters based on the prediction model acquired by the model acquisition unit 220 and the sensor data acquired by the data acquisition unit 210. Specifically, the optimization unit 230 predicts the furnace temperature using the prediction model according to the process recipe acquired by the data acquisition unit 210 and optimizes the correction parameters based on the error between the actual measured furnace temperature included in the sensor data and the predicted furnace temperature. The error may be an average value over the entire process recipe.

The optimization unit 230 may optimize the correction parameters using, for example, Bayesian optimization. However, the optimization method used by the optimization unit 230 is not limited to Bayesian optimization, and any mathematical optimization method may be used. In Bayesian optimization, the correction parameters may be optimized, for example, to minimize a root mean square error (RMSE). However, the error used for optimization is not limited to the RMSE, and any type of error may be used.

The root mean square error may be calculated using, for example, Equation (2):

$$RMSE [ °C . ] = \sqrt{\frac{1}{n} {\sum }_{i = 1}^{n} {( y ( i ) - {y}^{′} ( i ) )}^{2}} \qquad ( 2 )$$

Here, n is the number of sensor values included in the sensor data, y(i) is the predicted value of an i^{th} sensor value, and y′(i) is the actual measured value of the i^{th} sensor value.

In the substrate processing apparatus 120 where the interior of the processing container 10 is divided into a plurality of zones, the temperature in a certain zone is affected by all the first heaters 42 installed in the processing container 10. Since the prediction model takes the power input to each first heater 42 as an input, the correction parameters contain as many elements for each zone as the number of first heaters 42. Because it is difficult for a user to sequentially design all elements of the correction parameters, an optimization method based on machine learning, such as Bayesian optimization, enables efficient determination of the correction parameters.

The optimization unit 230 may iteratively optimize the correction parameters based on sensor data acquired at a plurality of points in time. In other words, the optimization unit 230 may optimize the correction parameters, which were optimized based on the sensor data measured at a first point in time, using the sensor data measured at a second point in time. Here, the second point in time is a later time than the first point in time.

For example, the optimization unit 230 may optimize the correction parameters each time the data acquisition unit 210 acquires sensor data. The optimization unit 230 may also optimize the correction parameters each time the target apparatus executes the process recipe, based on the sensor data generated during the execution of the process recipe by the process recipe.

The recipe reception unit 240 receives an input of the process recipe to be predicted. The process recipe may include a plurality of processes with different set temperatures for the processing container 10.

The prediction unit 250 predicts the furnace temperature of the target apparatus based on the optimized prediction model. The optimized prediction model includes the reference model acquired by the model acquisition unit 220 and the correction parameters optimized by the optimization unit 230. The prediction unit 250 may predict the furnace temperature of the target apparatus when executing the process recipe received by the recipe reception unit 240.

The prediction unit 250 outputs the predicted furnace temperature. The prediction results may include prediction data indicating the furnace temperature predicted by the prediction model. For example, the prediction unit 250 may display the prediction results on the output device 502 connected to the prediction apparatus 140.

### <Processing Procedure>

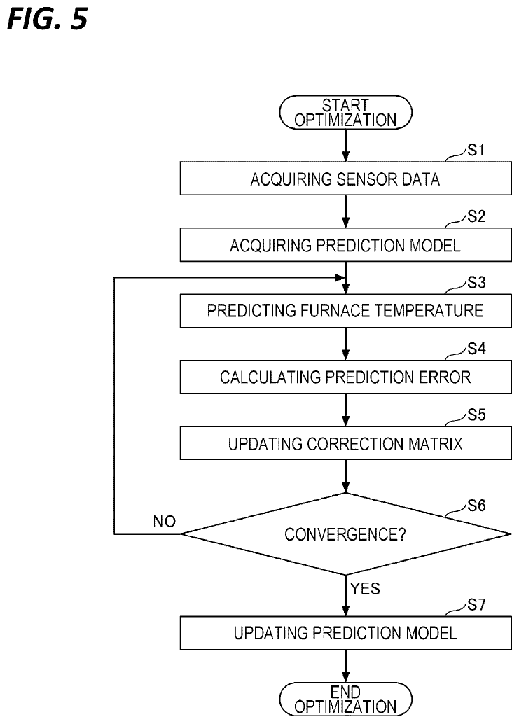

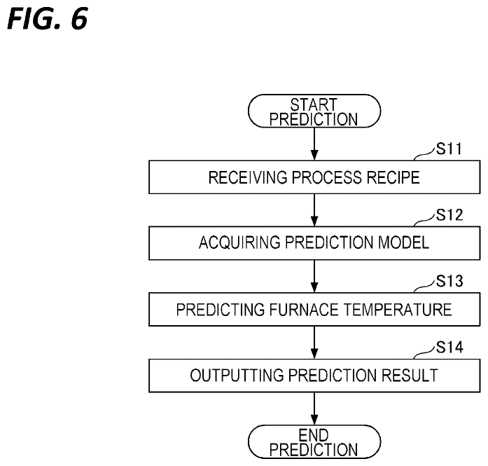

The information processing method executed by the substrate processing system 100 in the present embodiment will be described with reference to FIGS. 5 and 6. In the present embodiment, the information processing method includes an optimization process (see, e.g., FIG. 5) and a prediction process (see, e.g., FIG. 6).

### <<Optimization Process>>

FIG. 5 is a flowchart illustrating an example of an optimization process executed by the prediction apparatus 140. The optimization process is a process that optimizes the correction parameters based on sensor data generated in the target apparatus.

In step S1, the data acquisition unit 210 of the prediction apparatus 140 acquires sensor data generated in the target apparatus and a process recipe executed when the sensor data was generated. The data acquisition unit 210 acquires sensor data after the target apparatus has executed the process recipe at least once. The data acquisition unit 210 may acquire sensor data each time the target apparatus executes the process recipe. The data acquisition unit 210 transmits the acquired sensor data and the process recipe to the optimization unit 230.

In step S2, the model acquisition unit 220 of the prediction apparatus 140 reads a pre-trained prediction model from the model storage unit 201. The pre-trained prediction model includes the reference model and the correction parameters. The model acquisition unit 220 transmits the read prediction model to the optimization unit 230.

In step S3, the optimization unit 230 of the prediction apparatus 140 receives the sensor data and the process recipe from the data acquisition unit 210. In addition, the optimization unit 230 receives the prediction model from the model acquisition unit 220.

The optimization unit 230 acquires control information related to the temperature control of the processing container based on the process recipe. The optimization unit 230 inputs the acquired control information into the prediction model. The prediction model outputs a predicted furnace temperature based on the input control information. The predicted value output by the prediction model is a value obtained by correcting the predicted value output by the reference model using the correction parameters. The optimization unit 230 generates prediction data representing the predicted value output by the prediction model.

In step S4, the optimization unit 230 of the prediction apparatus 140 calculates a prediction error based on the prediction data and the sensor data. Specifically, the optimization unit 230 calculates a root mean square error (RMSE) between the prediction data and the sensor data for the entire process recipe in each zone of the processing container.

In step S5, the optimization unit 230 of the prediction apparatus 140 updates the correction parameters based on the prediction error calculated in step S4. Specifically, using Bayesian optimization, the optimization unit 230 designs new correction parameters, where the probability of reducing the prediction error is high. The optimization unit 230 updates the correction parameters included in the prediction model with the newly designed correction parameters.

In step S6, the optimization unit 230 of the prediction apparatus 140 determines whether a predetermined convergence condition is met. The convergence condition may include, for example, that the number of updates to the correction parameters is equal to or greater than a predetermined number or that the reduction in prediction error is equal to or smaller than a predetermined threshold.

When the convergence condition is met (YES), the optimization unit 230 proceeds to step S7. Meanwhile, when the convergence condition is not met (NO), the optimization unit 230 returns the process to step S3.

When the process returns to step S3, the optimization unit 230 re-executes steps S3 to S6 based on the prediction model in which the correction parameters were updated in the previous step S5. In this manner, the optimization unit 230 repeatedly performs furnace temperature prediction and correction parameter updates until determining in step S6 that the convergence condition is met.

In step S7, the optimization unit 230 of the prediction apparatus 140 stores the prediction model, which includes the optimized correction parameters, in the model storage unit 201. As a result, the prediction model stored in the model storage unit 201 is updated to the optimized prediction model.

### <<Prediction Process>>

FIG. 6 is a flowchart illustrating an example of a prediction process executed by the prediction apparatus 140. The prediction process is a process that predicts the furnace temperature of the target apparatus based on the prediction model, which includes the optimized correction parameters.

In step S11, the recipe reception unit 240 of the prediction apparatus 140 receives an input of the process recipe to be predicted. The recipe reception unit 240 transmits the received process recipe to the prediction unit 250.

In step S12, the model acquisition unit 220 of the prediction apparatus 140 reads the optimized prediction model from the model storage unit 201. The optimized prediction model includes the reference model and the optimized correction parameters. The model acquisition unit 220 transmits the read prediction model to the prediction unit 250.

In step S13, the prediction unit 250 of the prediction apparatus 140 receives the process recipe from the recipe reception unit 240. In addition, the prediction unit 250 receives the optimized prediction model from the model acquisition unit 220.

The prediction unit 250 acquires setting information related to the temperature control of the processing container based on the process recipe. The prediction unit 250 inputs the acquired setting information into the prediction model. The prediction model outputs a predicted furnace temperature based on the input setting information. The predicted value output by the prediction model is a value obtained by correcting the predicted value output by the reference model using the optimized correction parameters. The prediction unit 250 generates prediction data representing the predicted value output by the prediction model.

In step 514, the prediction unit 250 of the prediction apparatus 140 outputs the prediction results, which include the prediction data generated in step S13. Specifically, the prediction unit 250 displays the prediction results on the output device 502 connected to the prediction apparatus 140.

A user of the prediction apparatus 140 may verify the furnace temperature when the process recipe is executed in the target apparatus by referring to the prediction results output by the prediction apparatus 140. The user of the prediction apparatus 140 may utilize the verification results of the furnace temperature for the design or operation of the target apparatus or the process recipe.

### <Operation Flow>

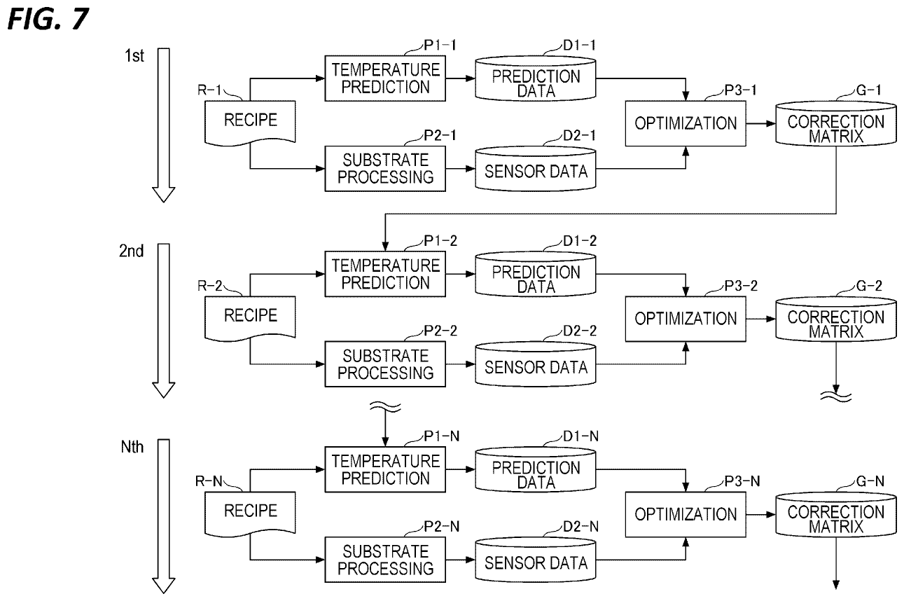

The operation flow of the prediction apparatus 140 will be described with reference to FIG. 7. FIG. 7 is a view illustrating an example of an operation flow of the prediction apparatus.

FIG. 7 illustrates an operation flow when a process is executed N times in the target apparatus. The process recipes used to execute respective processes may be the same or different. Each process recipe may be a recipe executed for manufacturing a product to be shipped.

In the first process, a process recipe R-1 is created by the user of the target apparatus. Then, based on the process recipe R-1, temperature prediction P1-1 based on a prediction model and substrate processing P2-1 by the target apparatus are performed. In the temperature prediction P1-1, only the prediction based on the reference model is performed. Subsequently, optimization P3-1 of correction parameters is performed based on prediction data D1-1 obtained in the temperature prediction P1-1 and sensor data D2-1 obtained in the substrate processing P2-1. As a result, an optimized correction matrix G-1 is generated.

In the second process, based on a process recipe R-2, temperature prediction P1-2 based on the prediction model and substrate processing P2-2 by the target apparatus are performed. In the temperature prediction P1-2, the predicted value output by the reference model is corrected using the correction matrix G-1 generated in the first process. Subsequently, optimization P3-2 of the correction parameters is performed based on prediction data D1-2 obtained in the temperature prediction P1-2 and sensor data D2-2 obtained in the substrate processing P2-2. As a result, an optimized correction matrix G-2 is generated.

Thereafter, in the same manner, the correction matrix G is optimized each time a process is executed. In the Nₜₕ process, based on a process recipe R-N, temperature prediction P1-N using the prediction model and substrate processing P2-N by the target apparatus are performed. In the temperature prediction P1-N, the predicted value output by the reference model is corrected using the correction matrix G generated in the (N-1)ₜh process. Subsequently, optimization P3-N of the correction parameters is performed based on prediction data D1-N obtained in the temperature prediction P1-N and sensor data D2-N obtained in the substrate processing P2-N. As a result, an optimized correction matrix G-N is generated.

Since the correction matrix G is always optimized based on the sensor data D2 most recently generated by the target apparatus, the influence of changes over time in the target apparatus may be suppressed. For example, when the target apparatus is relocated or undergoes maintenance, the operating environment of the target changes, which may result in a decrease in prediction accuracy. In the conventional technology, a special process needs to be executed to set up a new operating environment, but in this method, a correction matrix G optimized for the new operating environment may be obtained by executing the process once.

### <Verification Results>

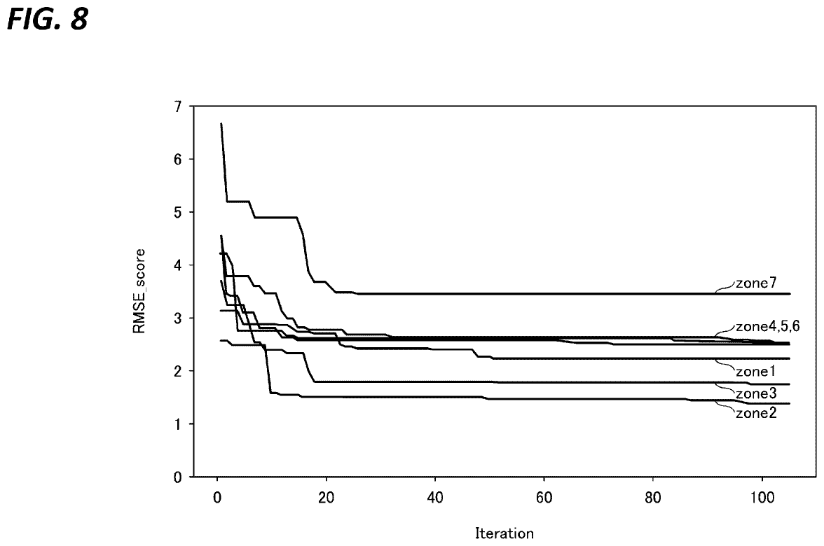

The verification results of the prediction apparatus 140 will be described with reference to FIGS. 8 to 11.

FIG. 8 is a diagram illustrating an example of a search process in Bayesian optimization. FIG. 8 illustrates a graph representing the transition of prediction error when the correction parameters are optimized using Bayesian optimization. The horizontal axis of FIG. 8 represents the number of iterations in Bayesian optimization, while the vertical axis represents a root mean square error (RMSE_score). The acquisition function for Bayesian optimization is Expected Improvement (EI).

As illustrated in FIG. 8, the prediction error converges within approximately 20 iterations for each of the seven zones inside the processing container. According to FIG. 8, it may be seen that Bayesian optimization is effective as a method for optimizing correction parameters.

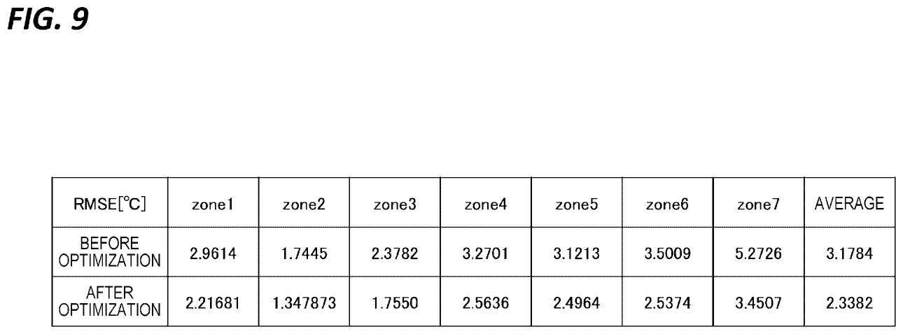

FIG. 9 is a diagram illustrating an example of the comparison results of prediction errors before and after optimization. FIG. 9 is a table comparing the root mean square error (RMSE) between sensor data and prediction data for each of Zones 1 to 7, before and after optimizing the correction parameters. The process recipe includes five processes with different set temperatures, and two temperature increase steps and two temperature decrease steps are executed.

As illustrated in FIG. 9, the root mean square error improves in all of Zones 1 to 7 after optimizing the correction parameters. FIG. 9 also illustrates that when averaging the root mean square error across all zones, prediction accuracy improves by 26.4%.

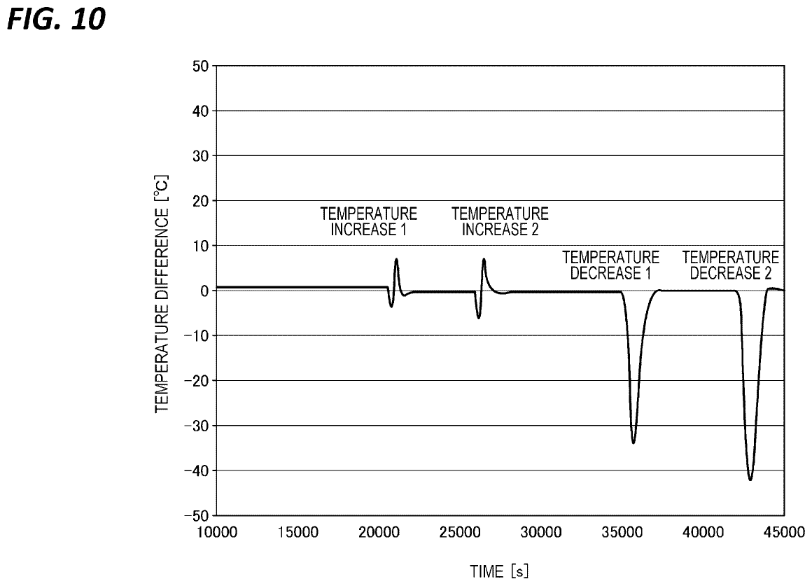

FIG. 10 is a diagram illustrating an example of prediction accuracy before optimization. FIG. 10 is a graph illustrating the transition of the temperature difference between predicted values and actual measured values when using correction parameters before optimization. The process recipe is the same as the one used when measuring the sensor data illustrated in FIG. 9, including two temperature increase steps and two temperature decrease steps. FIG. 10 illustrates the temperature difference between the predicted values and actual measured values in one zone.

As illustrated in FIG. 10, in the time interval in which the furnace temperature is stable, the temperature difference between the predicted values and actual measured values is small, and even with the correction parameters before optimization, the furnace temperature may be predicted with high accuracy. Meanwhile, in the time intervals in which the furnace temperature changes, the temperature difference between the predicted values and actual measured values increases, indicating that prediction accuracy decreases when the furnace temperature fluctuates.

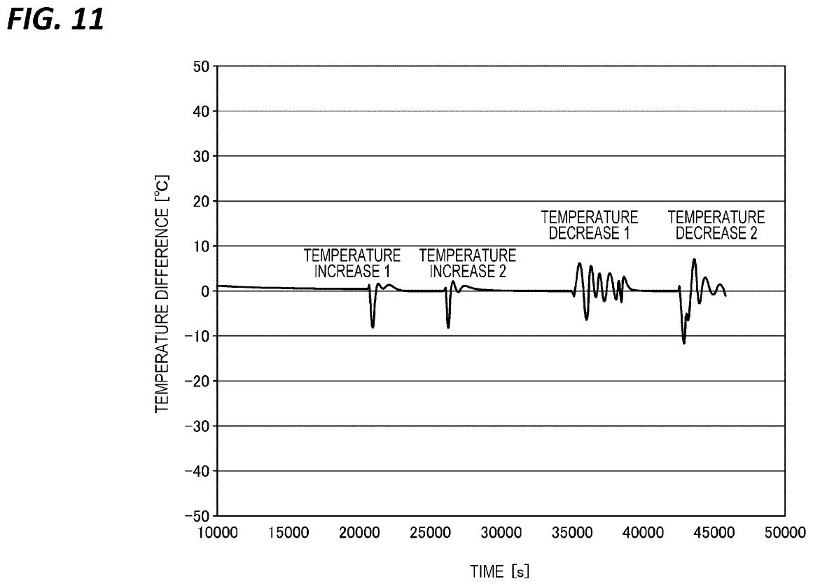

FIG. 11 is a diagram illustrating an example of prediction accuracy after optimization. FIG. 11 is a graph illustrating the transition of the temperature difference between predicted values and actual measured values when using correction parameters after optimization. The process recipe is the same as the one used when measuring the sensor data illustrated in FIG. 10, including two temperature increase steps and two temperature decrease steps. FIG. 11 illustrates the temperature difference between the predicted values and actual measured values in the same zone as illustrated in FIG. 10.

As illustrated in FIG. 11, in the time intervals in which the furnace temperature is stable, the temperature difference between the predicted values and actual measured values is small, and the furnace temperature may be predicted with high accuracy. Even in the time intervals in which the furnace temperature changes, the temperature difference between the predicted values and actual measured values is smaller than before optimization, indicating that accurate prediction is possible even when the furnace temperature changes.

### Effects of Embodiment

The prediction apparatus 140 in the present embodiment optimizes correction parameters that represent the difference in temperature responsiveness between the reference apparatus and the target apparatus, based on the reference model, which predicts the furnace temperature of the reference apparatus, and sensor data obtained by measuring the furnace temperature of the target apparatus, and predicts the furnace temperature of the target apparatus based on the reference model and the correction parameters.

In an aspect, according to the present embodiment, since the furnace temperature is predicted in consideration of the difference in temperature responsiveness between the reference apparatus and the target apparatus, the furnace temperature of the target apparatus may be predicted with high accuracy. In addition, according to the present embodiment, since the correction parameters may be optimized when sensor data measured during the execution of the process recipe is available, adaptation to changes in the target apparatus over time may be facilitated.

The prediction apparatus 140 may correct the furnace temperature predicted based on the reference model using the correction parameters. According to the present embodiment, since the difference in temperature responsiveness between the reference apparatus and the target apparatus may be reflected in the predicted value based on the reference model, the furnace temperature of the target apparatus may be accurately predicted even when using the reference model.

The prediction apparatus 140 may update the correction parameters based on the difference between the prediction data and the sensor data. The prediction apparatus 140 may optimize the correction parameters using Bayesian optimization. For example, in a substrate processing apparatus such as a vertical heat treatment apparatus, where a plurality of substrates are processed simultaneously, a plurality of heating units or cooling units are provided for furnace temperature control, resulting in a vast number of relationships between setting information and furnace temperature. According to the present embodiment, since the correction parameters are optimized using a machine-learning-based approach, the correction parameters may be efficiently calculated.

The correction parameters may represent the relationship between the setting information related to temperature control of the processing container and the temperature difference inside the processing container. The processing container is divided into a plurality of zones, and the correction parameters may represent the relationship between the setting information and the temperature difference in each zone. The setting information may include the power of the heating unit for heating the interior of the processing container and the output of the cooling unit for cooling the interior of the processing container. According to the present embodiment, even when the processing container is divided into a plurality of zones, the furnace temperature may be accurately predicted considering the temperature responsiveness in each zone.

The sensor data may be time-series data of furnace temperature measured when executing a recipe that includes a plurality of processes with different set temperatures. According to the present embodiment, since the correction parameters learned based on the relationship between the setting information related to temperature control and the furnace temperature are used, the furnace temperature may be accurately predicted even when executing a process recipe involving temperature changes.

The prediction apparatus 140 may optimize the correction parameters, which were optimized based on the sensor data measured at a first point in time, using the sensor data measured at a second point in time. Since the prediction apparatus 140 optimizes the correction parameters using the most recent sensor data, adaptation to changes in the target apparatus over time may be facilitated.

### OTHER EMBODIMENTS

A substrate processing apparatus that executes processes, including the substrate processing method disclosed herein, is not limited to a heat treatment apparatus. The substrate processing apparatus is applicable to any of an atomic layer deposition (ALD) type apparatus, a capacitively coupled plasma (CCP) type apparatus, an inductively coupled plasma (ICP) type apparatus, a radial line slot antenna (RLSA) type apparatus, an electron cyclotron resonance plasma (ECR) type apparatus, and a helicon wave plasma (HWP) type apparatus.

Furthermore, the substrate processing apparatus disclosed herein is applicable to any apparatus that performs a predetermined process (e.g., film deposition or etching) on a substrate, regardless of whether the apparatus utilizes plasma. In addition, the substrate processing apparatus disclosed herein is applicable to a single-wafer processing apparatus that processes substrates individually, a batch processing apparatus that processes a plurality of substrates simultaneously, and a semi-batch processing apparatus that processes a plurality of substrates at once in a quantity smaller than that of a batch processing apparatus.

In an aspect, the accuracy of predicting the temperature inside a processing container may be improved.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An information processing apparatus comprising:
model acquisition circuitry configured to acquire a trained model that predicts a temperature inside a processing container included in a first substrate processing apparatus;
data acquisition circuitry configured to acquire sensor data indicating a sensor value obtained by measuring a temperature inside a processing container included in a second substrate processing apparatus;
optimization circuitry configured to optimize a parameter indicating a difference in temperature responsiveness between the first substrate processing apparatus and the second substrate processing apparatus based on the trained model and the sensor data; and
prediction circuitry configured to predict the temperature inside the processing container included in the second substrate processing apparatus based on the trained model and the parameter.

2. The information processing apparatus of claim 1, wherein the prediction circuitry is configured to correct a predicted value of the temperature predicted based on the trained model using the parameter.

3. The information processing apparatus of claim 2, wherein the optimization circuitry is configured to update the parameter based on a difference between prediction data indicating the predicted value and the sensor data.

4. The information processing apparatus of claim 3, wherein the optimization circuitry is configured to optimize the parameter using Bayesian optimization.

5. The information processing apparatus of claim 1, wherein the parameter indicates a relationship between setting information related to a temperature control of the processing container and a temperature difference inside the processing container.

6. The information processing apparatus of claim 5, wherein the processing container is divided into a plurality of zones, and
wherein the parameter indicates a relationship between the setting information and the temperature difference in each zone.

7. The information processing apparatus of claim 5, wherein the setting information includes power of a heater that heats an interior of the processing container and an output of a cooler that cools the interior of the processing container.

8. The information processing apparatus of claim 1, wherein the sensor data is time-series data of the temperature measured when executing a recipe that includes a plurality of processes with different set temperatures.

9. The information processing apparatus of claim 1, wherein the optimization circuitry are configured to optimize the parameter, which is optimized based on the sensor data measured at a first point in time, using the sensor data measured at a second point in time.

10. An information processing method executed by an information processing apparatus, the method comprising:
acquiring a trained model that predicts temperature inside a processing container included in a first substrate processing apparatus;
acquiring sensor data indicating a sensor value obtained by measuring temperature inside a processing container included in a second substrate processing apparatus;
optimizing a parameter indicating a difference in temperature responsiveness between the first substrate processing apparatus and the second substrate processing apparatus based on the trained model and the sensor data; and
predicting the temperature inside the processing container included in the second substrate processing apparatus based on the trained model and the parameter.

11. A non-transitory computer-readable storage medium having stored therein a program that causes an information processing apparatus to execute a process including:
acquiring a trained model that predicts temperature inside a processing container included in a first substrate processing apparatus;
acquiring sensor data indicating a sensor value obtained by measuring temperature inside a processing container included in a second substrate processing apparatus;
optimizing a parameter indicating a difference in temperature responsiveness between the first substrate processing apparatus and the second substrate processing apparatus based on the trained model and the sensor data; and
predicting the temperature inside the processing container included in the second substrate processing apparatus based on the trained model and the parameter.
